(19) United States
(12) Patent Application Publication
(10) Pub. No.: US 2004/0051417 A1
(43) Pub. Date: Mar. 18, 2004

(54) Motor stator and method of manufacturing the motor stator

(76) Inventors: Akihiko Yamazaki, Fukui (JP); Takemi Ueda, Osaka (JP); Yasutake Seki, Fukui (JP); Yasuhiro Ishida, Fukui (JP); Kazunori Morita, Nara (JP)

Correspondence Address: Parkhurst & Wendel, Suite 210, 1421 Princet St, Alexanderia, VA, 22314-2805, US

(21) Appl. No.: 10/433,789

(22) PCT Filed: Nov. 26, 2001
(86) PCT No.: PCT/JP01/10298

(30) Foreign Application Priority Data
Dec. 7, 2000 (JP) 2000372647

(51) Int. Cl. H02K 1/00

(52) U.S. Cl. 310/216

(57) ABSTRACT

According to the present invention, film-shaped insulating materials (32) are provided in core slots (12), the insulating materials being extended by a specific dimension from the ends of outer peripheral cores (17) and inner peripheral cores (18) of core segments (11) to the outsides of the cores, and the plurality of core segments (11) are separated and held at specific intervals, so that winding can be continuously performed on split cores while a winding capability is maintained. Further, the core segments (11) are brought close to one another and rounded to form an annular shape while the film-shaped insulating materials (32) extended by the specific dimension to the outsides of the core are sequentially bent, so that it is possible to manufacture a stator ensuring an insulation distance between an exciting coil and the core and interphase insulation between out-of-phase coils.

### TECHNICAL FIELD

The present invention relates to a method of manufacturing a motor stator, in which a coil is formed on each magnetic pole teeth by salient pole concentrated winding, and a stator thereof, and particularly to a manufacturing method using split cores.

### BACKGROUND ART

FIG. 21 is a half section showing a typical motor. A rotor is pivotally supported on a bracket 50 via a bearing, and a stator 30 is provided so as to surround the rotor. An exciting coil 20 is wound around an insulator 31 provided on the rotor 30.

Regarding salient pole concentrated winding of the above motor stator 30, a method of winding a conductor on each of magnetic pole teeth via a nozzle has been generally performed. In order to improve a winding capability and increase a space factor of a winding in a core slot, a split core manufacturing method disclosed in JP6-105487A and so on has been widely adopted, in which a core is split to perform winding. Further, in order to reduce the cost by a decrease in man-hours, methods for continuously performing winding on split cores have been adopted. However, since exciting coils cannot be continuously wound when cores remain split, JP8-19196A adopts a continuous core, in which adjacent core segments are connected via thin portions, and discloses a continuous winding method for performing winding on the continuous core. JP9-163690A and JP10-336934A disclose a continuous winding method and so on, in which adjacent core segments are connected using a connecting tool and winding is performed on the core.

On the other hand, as to a structure and a manufacturing method for ensuring an insulation distance between an exciting coil and a core and insulation between adjacent out-of-phase coils in the split core manufacturing method, JP11-341747A and so on disclose a structure in which a sheet-like insulating material larger than the shape of a slot is used and the insulating material is bent to shield around a coil. Moreover, JP9-191588A and JP10-126997A disclose a method of manufacturing an insulating structural body in the continuous winding method.

However, the above conventional split core manufacturing method has the following problems: the continuous winding method cannot be performed, winding is interrupted, the shape of a core and so on are limited, the shape of an insulating material lacks stability, the number of man-hours is large, and cross wires and the like are hard to process.

### DISCLOSURE OF THE INVENTION

The object of the present invention is to provide a structure and a manufacturing method that can ensure an insulation distance between an exciting coil and a core and insulation between out-of-phase coils with high workability at low cost without degrading high-density winding, which is the original purpose of a split core manufacturing method.

In order to solve the above problem, according to the present invention, in a plurality of split core segments, film-shaped insulating materials extended by a specific dimension from the ends of outer peripheral cores and inner peripheral cores of the core segments are provided in core slots, and the plurality of core segments are separated and held at specific intervals, so that winding can be continuously performed in the split cores while ensuring a winding capability. Further, the core segments are rounded and shaped into an annular form while the film-shaped insulating materials extended by the specific dimension to the outsides of the cores are sequentially bent. Thus, it is possible to manufacture a stator which can ensure an insulation distance between the exciting coil and the core and interphase insulation between the out-of-phase coils.

Moreover, according to the present invention, in a core segment connected body for connecting a plurality of core segments, film-shaped insulating materials extended by a specific dimension from the ends of outer peripheral cores and inner peripheral cores of the core segments are provided in core slots, the core segments are rotated about connecting portions, and the plurality of core segments are opened and held at specific intervals, so that winding can be continuously performed in the split cores while ensuring a winding capability. Further, the core segments are rotated about the connecting portions and are brought close to one another to be rounded and shaped into an annular form while the film-shaped insulating materials extended by the specific dimension to the outsides of the cores are sequentially bent. Thus, it is possible to manufacture a stator which can ensure an insulation distance between the exciting coil and the core and interphase insulation between the out-of-phase coils.

Besides, according to the present invention, regarding cross wires caused by continuous winding and terminal wires, a coil hanging portion protruding toward a core slot is provided outside a turning region of a nozzle for winging on the inner surface of an outer peripheral side wall of an insulator, which is provided on both ends of a core of each core segment, and a winding end line of the winding is wound and fixed on the coil hanging portion, so that loosening of a wound exciting coil can be prevented and a stator can be manufactured with high workability.

Further, according to the present invention, regarding cross wires caused by continuous winding and terminal wires, after the plurality of core segments are rounded to form an annular stator, a housing box made of an insulating material is provided on a coil end of an end of the stator, and cross wires provided over exciting coils where winding is continuously performed are housed in the housing box via a sheet-like insulator while being separated for respective phases, so that a plurality of cross wires with the mixed phases can be processed with fewer man-hours and high insulating quality and a stator can be manufactured with high workability.

Additionally, according to the present invention, as to a height of an inner peripheral side wall of an insulator provided on both ends of a core of each core segment, a core slot internal dimension up to a boundary between adjacent core slots is used as the maximum dimension, two corners outside the inner peripheral side wall is cut smaller than the outer periphery of a wound exciting coil, an obstacle is eliminated in a turning region of a nozzle for winding, and the turning locus of the nozzle is provided according to the winding shape of an exciting coil as much as possible, so that it is possible to achieve high-density winding without loosening and to ensure a set region for a coil hanging portion and so on which protrudes into the core slot.

### BRIEF DESCRIPTION OF THE DRAWINGS

FIG. 1 is a plan view showing core segments on which continuous winding is performed in a three-phase brushless motor according to Example 1 of the present invention;

FIG. 2 is a plan view showing the core segment of Example 1;

FIG. 3 is a perspective view showing the core segment of Example 1;

FIG. 4 is a partial plan view showing the winding state of FIG. 1;

FIG. 5 is a plan view showing a core segment connecting body on which continuous winding is performed in a three-phase motor according to Example 2 of the present invention;

FIG. 6 is a partial plan view showing the winding state of FIG. 5;

FIG. 7 is an explanatory drawing showing manufacturing steps according to Example 3 of the present invention;

FIG. 8 is an explanatory drawing showing manufacturing steps according to Example 4 of the present invention;

FIG. 9 is an explanatory drawing showing manufacturing steps according to Example 5 of the present invention;

FIG. 10 is an explanatory drawing showing manufacturing steps according to Example 6 of the present invention;

FIG. 11 is an explanatory drawing showing manufacturing steps according to Example 7 of the present invention;

FIG. 12 is a perspective view showing a magnetic pole tooth for mounting an insulator having a coil hanging portion formed thereon according to Example 8 of the present invention;

FIG. 13 is a front view taken from the inner peripheral direction of the insulator according to Example 8 of the present invention;

FIG. 14 is a diagram showing a continuous winding pattern of one phase in a three-phase motor according to Example 8 of the present invention;

FIG. 15 is a divided perspective view showing an example of a cross wire housing box unit according to Example 9 of the present invention;

FIG. 16 is a perspective view showing the cross wire housing box according to Example 9 of the present invention;

FIG. 17 is a partial sectional view showing the cross wire housing box according to Example 9 of the present invention;

FIG. 18 is a sectional view showing a part of a motor for fixing the cross wire housing box according to Example 9 of the present invention;

FIG. 19 is a perspective view showing a cross wire housing box according to another example of the present invention;

FIG. 20 is a sectional view showing the cross wire housing box according to another example of the present invention;

FIG. 21 is a half section showing a typical motor;

FIG. 22 is a perspective view showing a single conventional core segment where winding is performed; and

FIG. 23 is an explanatory drawing showing a method of manufacturing a plurality of conventional core segments.

### BEST MODE FOR CARRYING OUT THE INVENTION

A method of manufacturing a motor stator of the present invention, in which splitting is performed for each magnetic pole tooth in the circumferential direction, a plurality of core segments are fit into each other to form an annular stator after winding is performed on the plurality of core segments, each having a concave fitting portion on one end of a split surface and a convex fitting portion on the other end of the split surface, wherein a film-shaped insulating material is provided in a core slot of each core segment, the insulating material being extended by a specific dimension from the ends of an outer peripheral core and an inner peripheral core of the core segment to the outsides of the cores, the core segments are separated at specific intervals, the core segments are held in series so that the teeth are arranged substantially in parallel, and continuous winding is sequentially performed without cutting cross wires between at least two exciting coils.

The above manufacturing method has the following effect: winding is continuously performed on the plurality of core segments, in which film-shaped insulating materials extended by the specific dimension from the ends of the outer peripheral cores and the inner peripheral cores of the core segments to the outside are held in the core slots, by using the whole slot region with no obstacles on winding and without the necessity for connection in postprocessing.

A method of manufacturing a motor stator according to the present invention, in which a stator iron core is formed as a core segment connected body having a plurality of core segments connected via yokes, the core segment including one tooth, and the core segment connected body is rounded to form an annular stator after winding is performed, wherein the core segments are connected so that the teeth are opened around connecting portions from substantially parallel positions, the core segment having a core slot including a film-shaped insulating material extended by a specific dimension from the ends of an outer peripheral core and an inner peripheral core to the outsides of the cores, the core segments are held so that the film-shaped insulating materials of the adjacent core segments do not interfere with each other, and continuous winding is sequentially performed without cutting cross wires between at least two exciting coils.

The above manufacturing method has the following effect: winding is continuously performed on the plurality of core segments, which hold film-shaped insulating materials extended by the specific dimension from the ends of the outer peripheral cores and the inner peripheral cores of the core segments to the outside, by using the whole slot region with no obstacles on winding and without the necessity for connection in postprocessing.

The method of manufacturing a motor stator of the present invention, wherein the extended portion of the film-shaped insulating material is pressed into the core slot from the outer periphery after winding is performed on the core segment, the insulating material being extended by the specific dimension from the end of the outer peripheral core of the core segment, and the plurality of core segments are brought close to one another after bending, the core segments having been separated and held at specific intervals, so that the extended portions of the bent film-shaped insulating materials are held between exciting coils of the plurality of core segments and a creepage insulation distance is ensured between the outer peripheral core and the exciting coil.

The above manufacturing method has the effect of readily forming a creepage insulating structural body on the outer peripheral sides of the core slots without considerably changing the winding state of the plurality of core segments where winding is continuously performed.

The method of manufacturing a motor stator according to the present invention, wherein the core segments are connected so as to be opened around the connecting portions from substantially parallel positions, winding is performed on the plurality of core segments which are held so as to permit no interference between the adjacent film-shaped insulating materials provided in the core slots, the plurality of core segments are rotated about the connecting portions and the core segments are brought close to one another, the core segments are rotated until the extended portions of the film-shaped insulating materials overlap each other, the insulating materials being extended by the specific dimension from the ends of the outer peripheral cores of the adjacent core segments to the outsides of the cores, the extended portions of the film-shaped insulating materials are pressed and bent into the core slots from the outer peripheral side, the film-shaped insulating materials being extended by the specific dimension from the cores, the core segments are rotated about the connecting portions again to bring the inner peripheral cores of the core segments close to one another until the extended portions of the bent film-shaped insulating materials are held between the exciting coils of the core segments, and a creepage insulation distance is ensured between the outer peripheral core and the exciting coil. The above manufacturing method has the effect of readily forming a creepage insulating structural body on the outer peripheral sides of the core slots without considerably changing the winding state of the plurality of core segments where winding is continuously performed.

The method of manufacturing a motor stator according to the present invention, wherein after winding is performed on the core segments, the plurality of core segments are bent into an annular shape until overlapping is made between the extended portions of the film-shaped insulating materials extended by the specific dimension from the ends of inner peripheral cores of the adjacent core segments to the outsides of the cores, the extended portions of the film-shaped insulating materials are pressed and bent in the core slots from the inner peripheral side of the annular core segments, and the inner peripheral cores of the plurality of core segments are brought close to one another again to form an annular stator, so that the extended portions of the bent film-shaped insulating materials are held between the exciting coils of the core segments and a creepage insulation distance is ensured between the inner peripheral core and the exciting coil.

The above manufacturing method has the following effect: by using the course of the process of forming the annular stator by rounding the plurality of core segments, on which winding is continuously performed, a creepage insulating structural body can be readily formed on the inner peripheral sides of the core slots.

The method of manufacturing a motor stator according to the present invention, wherein after winding is performed on the core segments, the core segments are rotated around the connecting portions of the core segments and the core segments are brought close to each other until overlapping is made between the film-shaped insulating materials extended by the specific dimension from the ends of the inner peripheral cores of the adjacent core segments to the outsides of the cores, the plurality of core segments are bent into an annular shape, the extended portions of the film-shaped insulating materials are pressed and bent into the core slots from the inner peripheral sides of the annular core segments, and the plurality of core segments are rotated about the connecting portions of the core segments again to bring the inner peripheral cores close to one another, so that the extended portions of the bent film-shaped insulating materials are held between the exciting coils of the core segments and a creepage insulation distance is ensured between the inner peripheral core and the exciting coil.

The above manufacturing method has the following effect: by using the course of the process of forming the annular stator by rounding the plurality of core segments, on which winding is continuously performed, a creepage insulating structural body can be readily formed on the inner peripheral sides of the core slots.

The method of manufacturing a motor stator according to the present invention, wherein the film-shaped insulating material has an overlapping dimension of the extended portions on the outer peripheral side and the inner peripheral side when the extended portions of the film-shaped insulating materials are bent into the core slots, the insulting materials being extended by the specific dimension from the ends of the outer peripheral cores and the inner peripheral cores to the outsides of the cores, and interphase insulation is ensured between the adjacent exciting coils when the plurality of core segments are adjacent to each other in an annular shape to form a stator.

The above manufacturing method has the following effect: the core segments are bent by using the course of the process of forming the annular stator by rounding the plurality of core segments, on which winding is continuously performed, so that an interphase insulating structural body can be readily formed.

A motor stator of the present invention that is formed into an annular shape by rounding a plurality of core segments after winding is performed on the plurality of core segments split for respective magnetic pole teeth in the circumferential direction, wherein the stator comprises a coil hanging portion protruding toward a core slot outside a turning region of a nozzle for winding on an inner surface of an outer peripheral side wall of an insulator provided on both ends of a core of the core segment, and a winding end line is wound and fixed on the coil hanging portion.

The above stator can readily wind and fix the winding end line without causing a failure during winding or changing the attitude of the nozzle after winding.

According to the stator of the present invention, a motor stator in which a plurality of core segments are rounded and formed into an annular shape after winding is continuously performed on the plurality of core segments split for respective magnetic pole teeth in the circumferential direction without cutting cross wires between at least two exciting coils, wherein after the plurality of core segments are rounded to form an annular stator, a housing box made of an insulating material is provided on coil ends of stator ends, and cross wires provided over the exciting coils are housed in the housing box via a sheet-like insulator while being separated for respective phases, the exciting coils having been subjected to continuous winding.

The stator has the effect of readily separating cross wires of respective phases generated in a mixed manner and housing the cross wires for the respective phases with fewer man-hours by continuous winding.

According to the stator of the present invention, a motor stator in which a plurality of core segments are rounded and formed into an annular shape after winding is continuously performed on the plurality of core segments split for respective magnetic pole teeth in the circumferential direction, wherein as to a height of an inner peripheral side wall of an insulator provided on both ends of a core of the core segment, a core slot internal dimension up to a boundary between adjacent core slots is used as the maximum dimension, and two corners outside the inner peripheral side wall are cut smaller than the outer periphery of a wound exciting coil while the strength of the inner peripheral side wall is maintained.

The stator can minimize the turning locus of the nozzle for winding, prevent loosening during winding, achieve high-density winding, and widely use a region outside the turning region.

The following will describe Examples of the present invention in accordance with the accompanying drawings.

### EXAMPLE 1

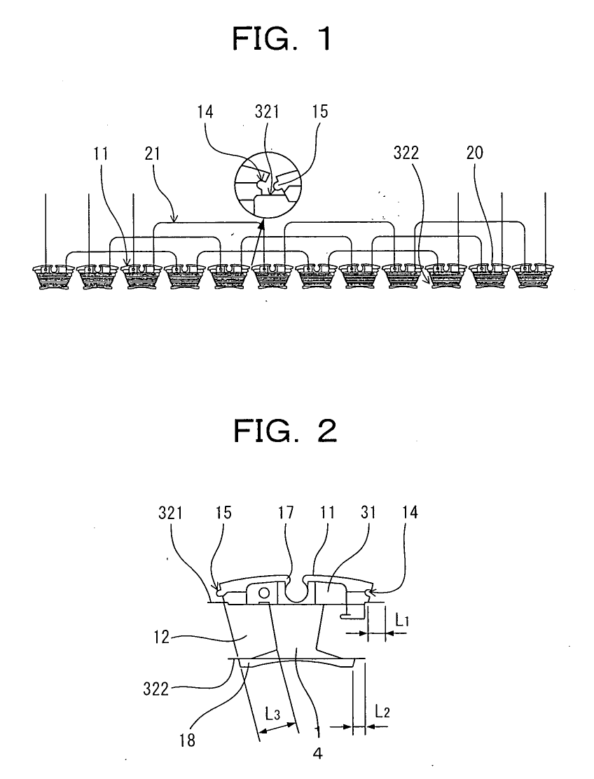

FIG. 1 shows that cross wires 21 between in-phase exciting coils 20 are continuously wound without being cut on split cores of a three-phase brushless motor having twelve slots.

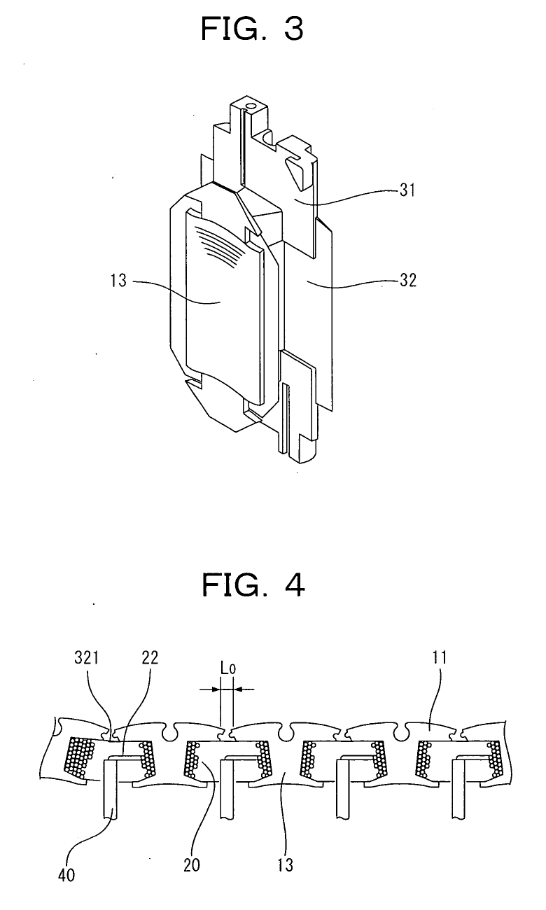

FIGS. 2 and 3 show each unit of magnetic pole teeth which are split in the circumferential direction before winding. The tooth 13 has a core segment 11 formed by laminating a plurality of thin iron plates, a film-shaped insulating material 32 for insulating adjacent exciting coils, and an insulator 31.

The core segment 11 has an outer peripheral core 17 and an inner peripheral core 18 which are connected to each other via a connecting portion, and core slots 12 on both sides in the laminating direction. A concave portion 14 formed on one of the ends of the outer peripheral core 17 and a convex portion 15 formed on the other end constitute a fitting portion for connecting the adjacent core segments 11.

Each of the core slots 12 comprises the film-shaped insulating material 32. An end 321 on the outer periphery of the film-shaped insulating material 32 is extended by L1 from the end of the outer peripheral core 17, and an end 322 on the inner periphery is extended by L2 from the end of the inner peripheral core 18. The insulator 31 is fit into both ends of the core segment 11 having the film-shaped insulator 32.

Regarding the lengths L1 and L2 for extending the end 321 on the outer periphery and the end 322 on the inner periphery of the film-shaped insulating material 32 and a creepage distance for insulation, the relationship expressed by the following equation is established. The following creepage distance for insulation indicates a distance between the outer peripheral core 17 and the exciting coil 20.

L1, L2>creepage distance for insulation

As shown in FIG. 4, separation is made by a specific interval L0 from the position for connecting the adjacent core segments 11, and the adjacent teeth 13 are held substantially in parallel. Further, the specific interval L0 is set so as to maintain a state in which the ends 321 on the outer peripheries of the adjacent film-shaped insulating materials 32 overlap each other and do not enter the core slots 12 of the adjacent core segments 11. The specific interval L0 is an element determining a length of the cross wire 21 caused by continuous winding. It is preferable to minimize the interval L0 in consideration of simplicity of wire processing work in postprocessing and the cost.

Further, as shown in FIG. 4, the ends 321 on the outer peripheries of the adjacent film-shaped insulating materials 32 overlap each other like a flat surface because the insulating materials are shaped like thin films. The overlapping portions of the film-shaped insulators 32 are shaped like flat surfaces and do not protrude into the core slot 12. Thus, the overlapping potion does not interfere with a sliding region of a nozzle 40, so that the nozzle 40 is highly controllable over the position of the coil 22 and winding can be performed with a high density by using the whole region of the core slot 12.

As described above, the positional relationship of the core segments 11 shown in FIG. 4 is maintained and the twelve core segments 11 are held in series, so that necessary exciting coils 20 can be continuously wound as shown in FIG. 1.

In contrast, FIG. 22 is a perspective view showing a unit of a conventional magnetic pole tooth. In FIG. 22, reference numeral 11 denotes a core segment formed by laminating a plurality of thin iron plates, reference numeral 32 denotes a film-shaped isolating material for insulating adjacent exciting coils, and reference numeral 31 denotes an insulator. In this conventional example, an exciting coil 20 is wound for each of the magnetic pole teeth and the coil 22 is cut.

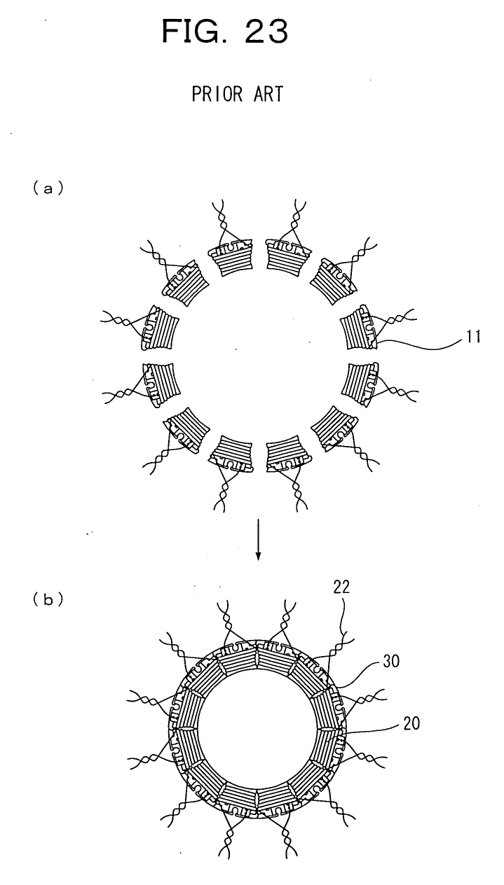

In the conventional method of manufacturing a stator, a required number of magnetic pole teeth are produced and are arranged like FIG. 23(a), and the core segments 11 are connected like an annular shape as shown in FIG. 23(b). The in-phase coils 22 are connected later. The conventional method requires more man-hours for connection as compared with the present example and thus automation becomes difficult.

### EXAMPLE 2

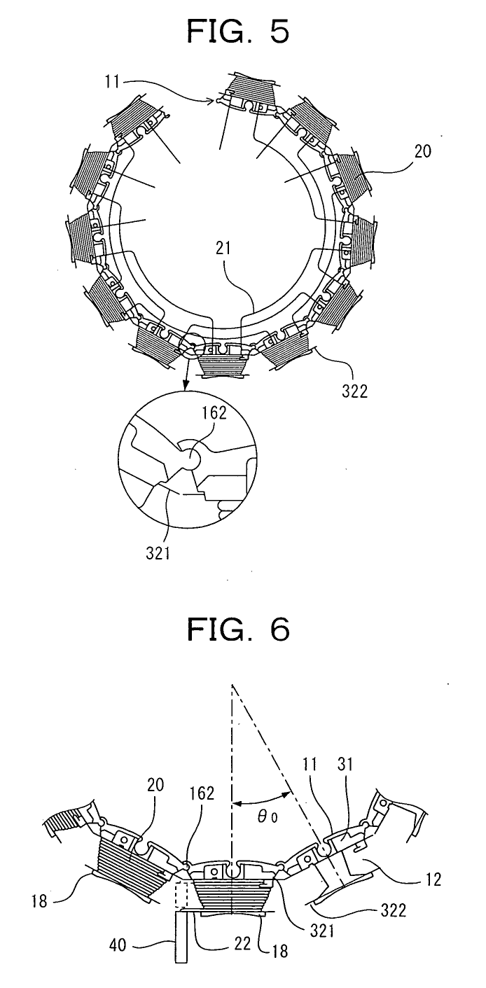

FIG. 5 shows that cross wires 21 between in-phase exciting coils 20 are continuously wound without being cut on the connecting cores of a three-phase brushless motor having twelve slots. As shown in FIG. 6, in this example, core segments 11 are connected so that teeth 13 are opened around a connecting portion 162, and the adjacent core segments 11 are held with a specific angle of θ0. The specific angle θ0 is set so as to maintain a state in which no interference occurs between extended portions on outer peripheral ends 321 of adjacent film-shaped insulating materials 32. Since the extended portions on the ends of the film-shaped insulating materials 32 do not interfere with each other, the flatness is not degraded on the outer peripheral ends 321 of the film-shaped insulating materials 32 (virtual lines of FIG. 6) and any obstructions are not found in a sliding region of a nozzle 40. Thus, winding can be performed with a high density while the nozzle 40 is highly controllable over the position of the coil 22 and the whole region of the core slot 12 is used.

As described above, the positional relationship of the core segments 11 of FIG. 6 is maintained and the twelve core segments 11 are held, so that required exciting coils 20 can be continuously wound as shown in FIG. 5.

### EXAMPLE 3

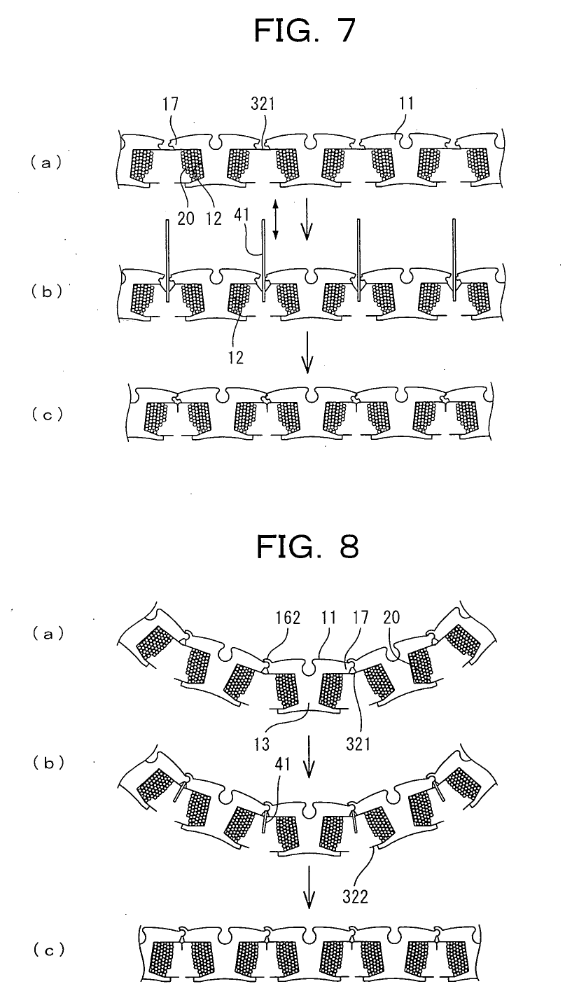

FIG. 7 shows a part of a line having a plurality of core segments 11, on which winding is performed as shown in FIG. 1, and the steps of forming a creepage insulating structural body between outer peripheral cores 17 and exciting coils 20 of the core segments 11.

As shown in FIG. 4, the core segments 11 are separated from one another at specific intervals L0, adjacent teeth 13 are held substantially in parallel, and winding is performed (FIG. 7(a)). Then, the extended portions on ends 321 of film-shaped insulating materials, which are extended by a specific dimension from the ends of the outer peripheral cores 17 of the core segments 11, are pressed and bent into core slots 12 by blades 41 from the outer peripheral sides (FIG. 7(b)). The outer peripheral cores 17 of the plurality of core segments 11, which have been separately held at the specific intervals L0, are brought close to each other until contact occurs, so that the extended portions on the ends 321 of the bent film-shaped insulating materials are folded inward and are held to form a creepage insulating structural body (FIG. 7(c)).

As described above, without changing the series configuration after winding, with a simple method for readily performing automation, in which the extended portions on the ends 321 of the film-shaped insulating materials are pressed inward by the plurality of blades 41 from the outer peripheral sides and the outer peripheral cores 17 of the core segments 11 are brought close to each other until contact occurs, it is possible to ensure a creepage distance for insulation between the outer peripheral cores 17 and the exciting coils 20.

In the process of bringing the core segments 11 into contact with each other after bending the extended portions on the outer peripheral sides of the film-shaped insulating materials, the outer peripheral cores 17 of the core segments 11 do not need to make contact with each other. The adjacent core segments 11 only need to be brought close to each other by a moving distance permitting the function of holding the extended portions 321 on the outer peripheral sides of the bent film-shaped insulating materials.

### EXAMPLE 4

FIG. 8 shows a part of a line having a plurality of connecting cores, on which winding is performed as shown in FIG. 5, and the steps of forming a creepage insulating structural body between outer peripheral cores 17 and exciting coils 20 of core segments 11.

As shown in FIG. 6, the core segments 11 are connected so as to be opened around connecting portions 162. The adjacent core segments 11 are held with a specific angle of θ0 and winding is performed (FIG. 8(a)). Then, the core segments 11 are rotated about the connecting portions 162 and inner peripheral cores 18 are brought close to each other. The core segments 11 are rotated until ends 321 of film-shaped insulating materials overlap each other. The film-shaped insulating materials have been extended by a specific dimension from the ends of the outer peripheral cores 17 to the outsides of the cores. Blades 41 are pressed into core slots 12 from openings between the core segments connected via the connecting portions 162, and the extended portions on the ends 321 of the film-shaped insulators are bent (FIG. 8(b)). Furthermore, the core segments 11 are rotated about the connecting portions 162 and the inner peripheral cores 18 are brought close to one another until teeth 13 of the core segments 11 are arranged substantially in parallel. In this way, the extended portions on the ends 321 of the bent film-shaped insulating materials are folded inward and are held to form a creepage insulating structural body (FIG. 8(c)).

As described above, with the simple method for readily performing automation, in which the plurality of core segments 11 are rotated about the connecting portions 162, the plurality of blades 41 are pressed inward from the outer peripheral sides, and the core segments 11 are rotated to bring the inner peripheral cores 18 close to each other, it is possible to ensure a creepage distance for insulation between the outer peripheral cores 17 and exciting coils 20.

Additionally, in the process of rotating the core segments 11 again and bringing the core segments 11 close to each other after bending the extended portions on the ends 321 of the film-shaped insulators, it is not necessary to bring the core segments 11 close to each other until the teeth 13 are arranged substantially in parallel. Rotation needs to be performed only with an angle permitting the function of holding the extended portions on the ends 321 of the bent film-shaped insulating materials.

### EXAMPLE 5

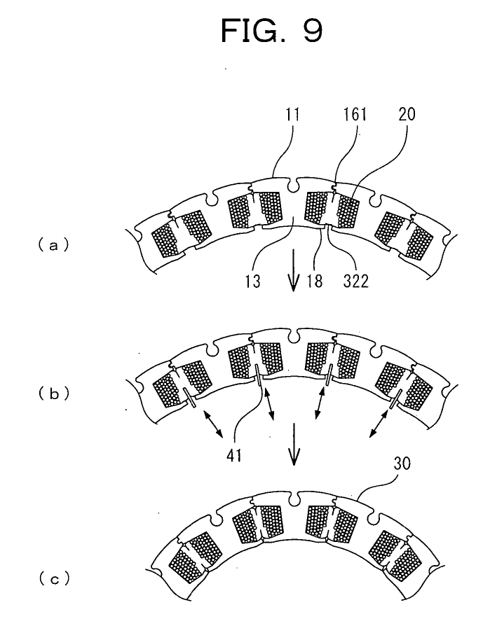

FIG. 9 shows the steps of forming a creepage insulating structural body between inner peripheral cores 18 and exciting coils 20 of a line having a plurality of core segments 11, on which a creepage insulating structural body of FIG. 7 has been formed between outer peripheral cores 17 and the exciting coils 20, after winding is performed on the core segments 11 as shown in FIG. 1.

Prior to the step of FIG. 9(a), as shown in FIG. 7(c) in a state in which teeth 13 are kept in parallel, the outer peripheral cores 17 are brought close to each other until contact occurs, and a creepage insulating structural body is formed between the outer peripheral cores 17 and the exciting coils 20.

The plurality of core segments 11 shown in FIG. 7(c) are fixed on holding tools (not shown) which can freely rotate about contact points 161 between the core segments 11. The plurality of core segments 11 held on the holding tools are rotated about the contact points 161 until overlapping is made between the extended portions on inner peripheral ends 322 of film-shaped insulating materials which are extended from the ends of the inner peripheral cores 18 (FIG. 9(a)).

Then, the extended portions that have overlapped each other on the ends 322 of the film-shaped insulating materials are pressed into core slots 12 by blades 41 from the inner peripheral sides of the cores and are bent therein (FIG. 9(b)).

Further, the plurality of core segments 11 are rotated about the contact points 161 and the inner peripheral cores 18 are brought close to each other and make contact with each other, so that an annular stator 30 is formed. The extended portions on the ends 322 of the film-shaped insulating materials are bent into the core slots 12 and are held to form a creepage insulating structural body.

As described above, with the method of rotating the plurality of core segments 11 about the contact points 161, pressing the plurality of blades 41 inward from the inner peripheral side, bending the extended portions on the ends 322 of the film-insulating materials to the core slots 12, and rotating the core segments 11 again to bring the inner peripheral cores 18 close to each other, it is possible to readily perform manufacturing using tools. With the simple method permitting automation, it is possible to form the annular stator 30 while ensuring a creepage distance for insulation between the inner peripheral cores 18 and the exciting coils 20.

### EXAMPLE 6

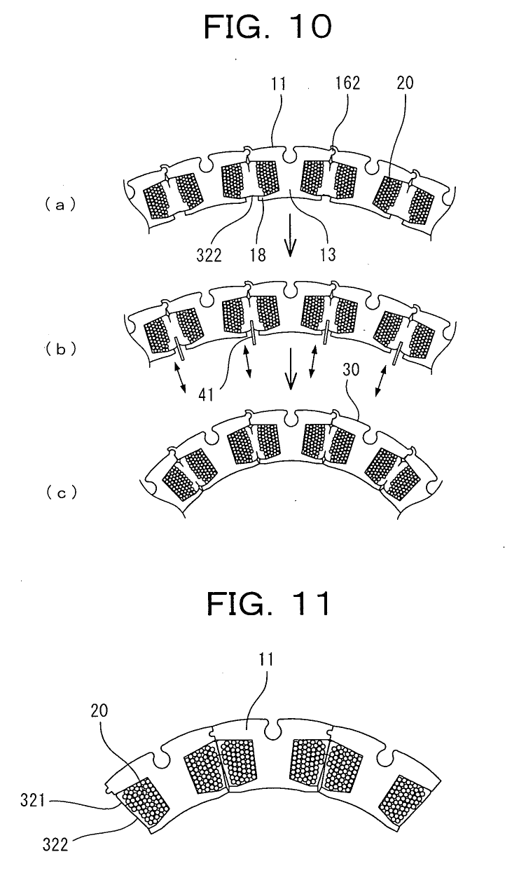

FIG. 10 shows the steps of forming a creepage insulating structural body between inner peripheral cores 18 and exciting coils 20 of a line having a plurality of core segments 11 shown in FIG. 8 after winding is performed on the core segments 11 as shown in FIG. 5.

From a state in which teeth 13 of FIG. 8(c) are kept substantially in parallel, the core segments 11 are rotated about connecting portions 162 to bring the inner peripheral cores 18 close to each other, and overlapping is made between the extended portions of ends 322 on the inner peripheral side of film-shaped insulating materials, which are extended by a specific dimension from the ends of the adjacent inner peripheral cores 18 (FIG. 10(a)).

Then, the extended portions that overlap each other on the ends 322 of the film-shaped insulating materials are pressed into core slots 12 by blades 41 from the inner peripheral sides of the cores and are bent therein (FIG. 10(b)).

Further, the plurality of core segments 11 are rotated about the contact points 161 and the inner peripheral cores 18 are brought close to each other to make contact with each other, so that an annular stator 30 is formed. The extended portions on the ends 322 of the film-shaped insulating materials are bent into the core slots 12 and are held to form a creepage insulating structural body.

As described above, with the method of rotating the plurality of core segments 11 about the contact points 161, pressing the plurality of blades 41 inward from the inner peripheral sides, bending the extended portions on the ends 322 of the film-shaped insulating materials into the core slots 12, and rotating the core segments 11 again to bring the inner peripheral cores 18 close to each other, it is possible to perform manufacturing using tools. With the simple method permitting automation, it is possible to form the annular stator 30 while ensuring a creepage distance for insulation between the inner peripheral cores 18 and the exciting coils 20.

### EXAMPLE 7

FIG. 11 shows a part of a line having a plurality of core segments according to the present example. When extended portions of ends 321 on the outer peripheral sides of the film-shaped insulating materials and extended portions of ends 322 on the inner peripheral sides are bend into core slots 12, the present example has dimensions of the extended portions of ends 321 and the ends 322 that overlap each other. Moreover, after winding is performed on the plurality of core segments 11, the extended portions of the ends 321 and the extended portions of the ends 322 are caused to overlap each other, and the plurality of core segments 11 are rounded to form an annular core.

In winding of the split cores shown in FIG. 1, in order to ensure interphase insulation between adjacent exciting coils 20, as shown in FIG. 11, the present example has dimensions of the extended portions of the outer peripheral ends 321 and the extended portions of the inner peripheral ends 322 that overlap each other. Winding is performed on the plurality of core segments having the film-shaped insulating materials 32 on the core slots 12. At this point, a specific interval L0 between the adjacent core segments 11 is set so that the extended portions on the ends 321 of the adjacent film-shaped insulating materials 32 overlap each other and can be kept from entering the core slots 12 of the adjacent core segments 11 as in Example 1.

The process of forming the annular shape after winding is the same as those of Examples 3 and 5. As with the case of forming the above creepage insulating structural bodies, it is possible to form an annular stator 30 while ensuring interphase insulation between the exciting coils 20 with a simple method permitting automation.

Besides, regarding a method of extending the extended portions 321 on the ends 321 and the extended portions on the ends 322 of the film-shaped insulating materials until the extended portions overlap each other, the extended dimension of the extended portion 322 on the inner peripheral side and the extended dimension of the extended portion 321 on the outer peripheral side have the following relationship:

extended dimension of the extended portion on the inner peripheral side>extended dimension of the extended portion on the outer peripheral side

With the above dimensions, it is possible to minimize the extension of the specific interval L0 between the core segments and achieve simplified wire processing work on cross wires and in postprocessing.

### EXAMPLE 8

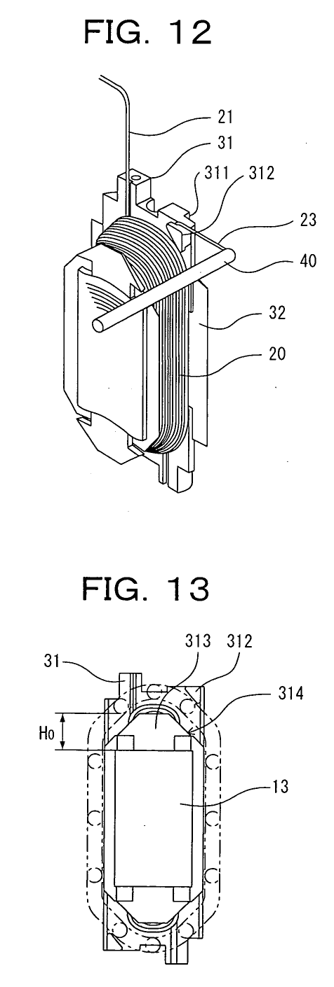

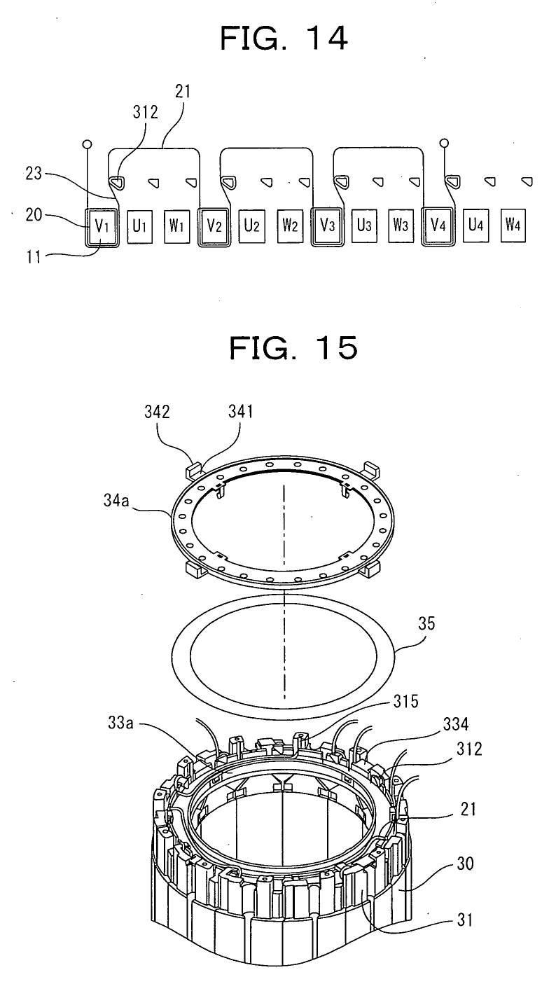

FIG. 12 is a perspective view showing that winding is performed on a core segment 11, which comprises an insulator 31 having a coil hanging portion formed thereon, by a nozzle 40 for winding. FIG. 13 shows a configuration in which a coil hanging portion 312 protruding toward a core slot 12 is provided outside a region for turning the nozzle 40 for winding on the inner surface of the outer peripheral side wall of the insulator. Further, FIG. 14 is a diagram showing a winding pattern of one phase using the coil hanging portion.

Referring to FIG. 14, the present example will be discussed below. First, after winding is performed on V1 of the core segment 11, a winding end line 23 is wound around the coil hanging portion 312 and is fixed thereon, the winding is shifted to V2 of the subsequent core segment 11 via a cross wire 21, and winding performed on V2. In this way, winding is sequentially performed on V3 and V4 of the core segment.

Fixing the winding end line 23 on the coil hanging portion is an important condition for reducing the man-hours in wire processing on the cross wires 21 and the like in postprocessing. It is possible to readily perform wire processing without changing the winding state.

Moreover, outside the region for turning the nozzle 40 for winding, the coil hanging portion 312 is provided on an inner surface region of an outer peripheral side wall 311 of the insulator. The inner surface region is in an interval of the exciting coil 20 and is not used. Thus, the coil hanging portion 312 does not interfere with the nozzle 40 for winding when winding is performed. Additionally, the coil hanging portion 312 is protruded into the core slot 12, so that the winding end line 23 can be readily wound and fixed without changing the attitude of the nozzle 40 after winding is performed.

### EXAMPLE 9

FIG. 15 is an exploded perspective view showing a cross wire housing box unit provided on a stator of the present example. In this example, after a plurality of core segments 11 are rounded to assemble an annular stator 30, a housing box 33a made of an insulating material is provided on an end of the stator 30, cross wires 21 provided over exciting coils 20, on which winding is continuously performed, are separated for respective phases via a sheet-like insulator 35 and are housed in three stages in the housing 33a, and housed members such as the cross wire 21 are contained in the housing box 33a by a lid 34a for fixation. Besides, although the two sheet-like insulators 35 are necessary in a three-phase motor, one of the insulators is omitted in FIG. 15.

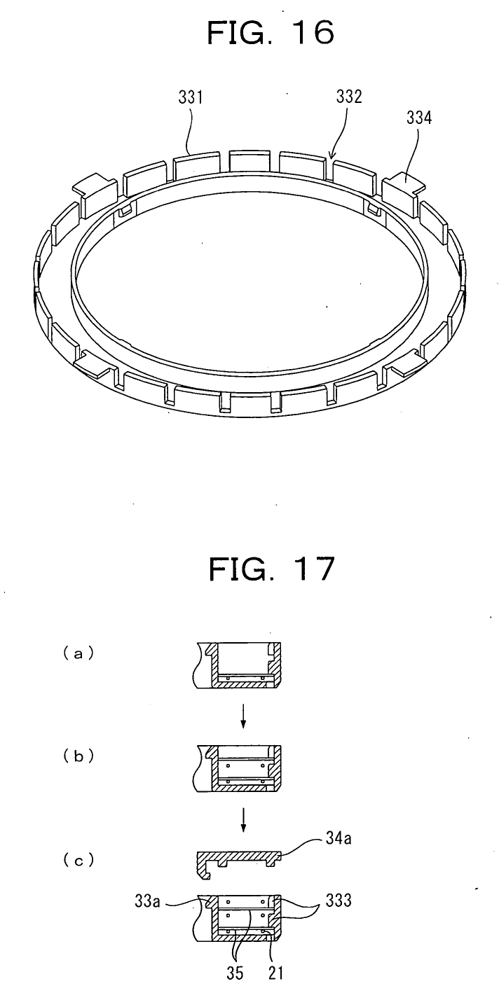

FIG. 16 is a perspective view showing the housing box 33a. The housing box 33a is positioned and held on the insulators 31 by mounting arms 334 which protrude toward the outer periphery.

Further, on an outer peripheral wall 331 of the housing box 33a, slits 332 for the cross wires 21 are provided in accordance with the positions of coil hanging portions 312 and the positions of winding start grooves 315 of the insulators 31 provided on the core segments 11, so that the cross wires 21 fixed on the coil hanging portions 312 can be housed with high workability.

Besides, FIGS. 17(a) to 17(c) are partial sectional views showing the housing box 33a. Every time the cross wire 21 of each phase is housed in the housing box 33a, the cross wire 21 is covered with the sheet-like insulator 35 for interphase insulation. Two kinds of steps 333 on different positions are provided on an outer peripheral wall 331 of the housing box 33a, the outer peripheral edges of the sheet-like insulator 35 are locked into the steps 333, and two sheet-like insulators 35 can be fixed as interphase insulation among three phases.

Moreover, as shown in FIG. 15, the lid 34a for fixation is positioned and held on the insulators 31 by mounting arms 341 protruding toward the outer periphery. The lid 34a for fixation can be fixed in the housing box 33a in a fitting manner. The lid 34a contains housed members in the housing box 33a and insulates the housed members from the outer periphery including a bracket 50.

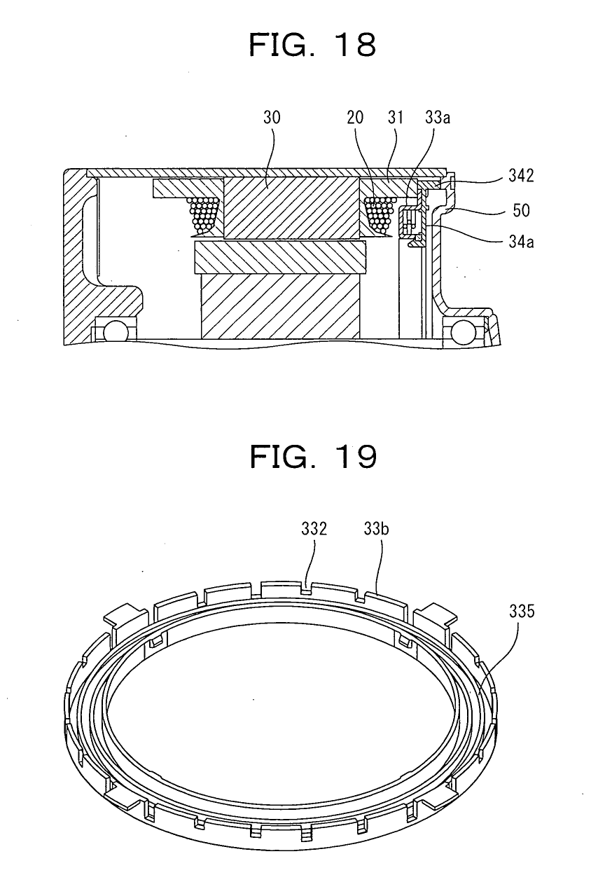

Further, protrusions 342 for fixation are provided on the mounting arms 341 protruding toward the outer periphery of the lid 34a for fixation. As shown in FIG. 18, the protrusions 342 for fixation are pressed onto the stator 30 by the bracket 50 via the insulators 31 when a motor is assembled, so that the housing box 33a can be fixed on the stator 30 without the necessity for a fastening component.

Besides, it is needless to say that when interphase insulation between the cross wires 21 of respective phases is not necessary, the cross wires 21 of the respective phases generated in a mixed manner can be readily housed as they are by using the whole housing box 33a, without the necessity for the sheet-like insulator 35.

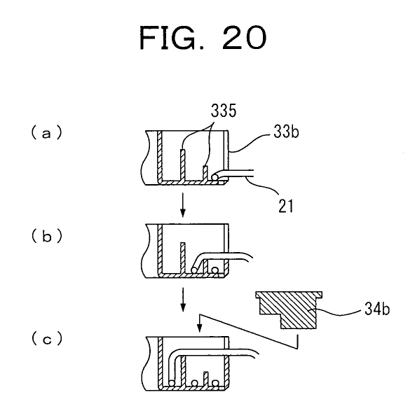

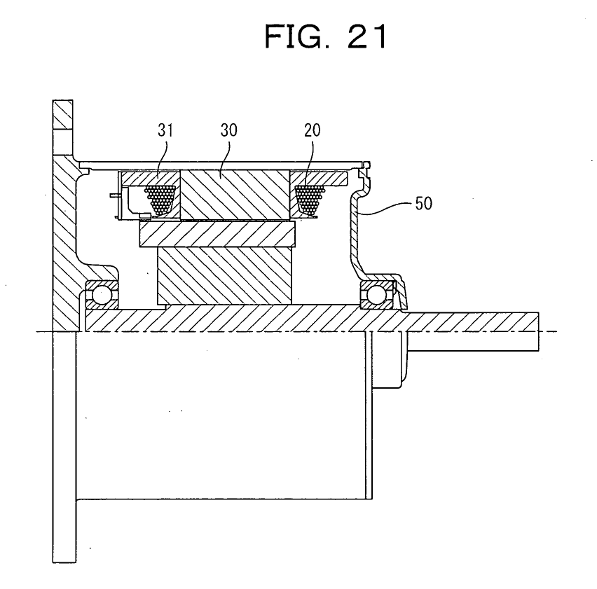

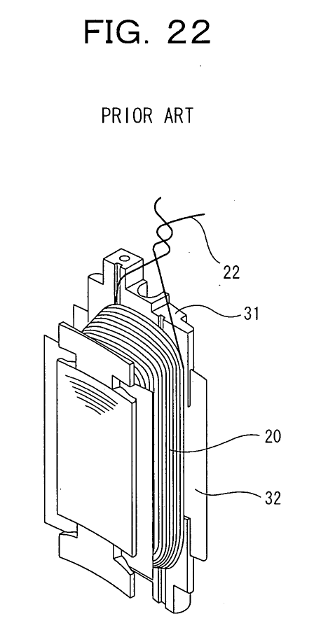

Further, FIG. 19 shows another example of the housing box and FIG. 20 is a partial sectional view showing the housing box. A housing box 33b of FIG. 20 is an example in which two separation walls 335 are provided on the bottom of the housing box 33b in parallel with the outer peripheral wall and the inner peripheral wall of the housing box so as to permit separation for each phase. The two separation walls 335 and the slits 332 on the outer peripheral wall are changed in depth, so that interphase insulation can be provided on the wiring of the cross wires to the housing box 33b. In FIG. 20, the height of the separation wall 335 and the slits of the inner peripheral wall are formed so as to correspond to each other. Furthermore, a step suitable for the height of the separation wall 335 is provided on the bottom of the lid 34b for fixation of FIG. 20, so that each phase can be separated without the necessity for the sheet-like insulator.

### EXAMPLE 10

Referring to FIGS. 12 and 13, Example 10 will be discussed below. In this example, the shape of an internal side wall 313 is limited on an insulator 31 provided on both ends of a core of each core segment, so that a nozzle 40 can be controlled with a small turning locus.

First, as to a height H0 of the internal peripheral side wall 313 of the insulator, as shown in FIG. 2, when it is assumed that a dimension L3 is provided between the inner peripheral base of the inner peripheral side wall 313 of the insulator and a boundary between adjacent core slots 12 (line connecting an end of an outer peripheral core 17 and an end of an inner peripheral core 18), since an exciting coil is not wound as large as the inner peripheral dimension L3 of the core slot, the height H0 is limited like H0<L3 and is not increased more than necessary.

Further, corners 314 on both external sides of the inner peripheral side wall 313 of the insulator are cut like trapezoids smaller than the outer peripheral edge of a wound exciting coil 20 so that the strength of the inner peripheral side wall 313 can be maintained. Thus, an obstacle is eliminated in a turning region of a nozzle 40 for winding. The turning locus of the nozzle 40 is provided according to the winding shape of the exciting coil 20 as much as possible, so that loosening of a coil 22 is suppressed and high-density winding is achieved without uneven winding.

Moreover, since the turning locus of the nozzle 40 limited to a minimum, it is possible to widely use a region outside the turning region of the nozzle and sufficiently ensure a region for setting a coil hanging portion 312 which protrudes into a core slot as shown in Example 8.

With the above configuration, the present invention can obtain the following effect: by using split cores or connecting cores, a coil is wound around a core segment having a film-shaped insulating material on a core slot, the insulating material being extended by a specific dimension from the ends of an outer peripheral core and an inner peripheral core of the core segment, the whole slot region is used with a high density, which is the original purpose of the split cores, and continuous winding can be performed without the necessity for a connecting operation in the postprocessing of winding.

Moreover, according to the present invention, the following effect can be achieved: without largely changing the winding state of the plurality of core segments on which continuous winding is performed using split cores or connecting cores, a creepage insulating structural body can be readily formed on the outer peripheral sides of the core segments.

Additionally, according to the present invention, the following effect can be achieved: by using the course of the process of forming an annular stator by rounding a plurality of core segments, on which winding is continuously performed using split cores or connecting cores, a creepage insulating structural body can be readily formed on the inner peripheral sides of the core segments.

Further, according to the present invention, it is possible to obtain the effect of readily forming an interphase insulating structural body by using the course of the process of rounding a plurality of core segments, on which winding is continuously performed, to form an annular stator.

Besides, according to the present invention, the following effect can be achieved: a winding end line can be readily wound and fixed without causing a failure during winding and man-hours can be reduced for wire processing of cross wires and so on in postprocessing.

Further, according to the present invention, the following effect can be achieved: cross wires of respective phases generated in a mixed manner can be readily separated and housed for the respective phases with fewer man-hours by continuous winding, so that the man-hours for wire processing can be remarkably reduced while ensuring interphase insulation.

Additionally, according to the present invention, the following effects can be achieved: a turning locus of a nozzle for winding is minimized, loosening is prevented during winding, high-density winding is achieved, and a region outside a turning region can be widely used.

1. A method of manufacturing a motor stator, in which splitting is performed for each magnetic pole tooth in a circumferential direction, a plurality of core segments are fit into each other to form an annular stator after winding is performed on the plurality of core segments, each having a concave fitting portion on one end of a split surface and a convex fitting portion on the other end of the split surface, the method comprising:
providing a film-shaped insulating material in a core slot of each core segment, the insulating material being extended by a specific dimension from ends of an outer peripheral core and an inner peripheral core of the core segment to an outside of the core, separating the core segments at specific intervals, holding the core segments in series so that the teeth are arranged substantially in parallel; and
sequentially performing continuous winding without cutting a cross wire between at least two exciting coils.

2. A method of manufacturing a motor stator, in which a stator iron core is formed as a core segment connected body having a plurality of core segments connected via yokes, the core segment including one tooth, and the core segment connected body is rounded to form an annular stator after winding is performed, the method comprising:
connecting the core segments so that the teeth are opened around connecting portions from substantially parallel positions, the core segment having a film-shaped insulating material in a core slot, the insulating material being extended by a specific dimension from ends of an outer peripheral core and an inner peripheral core to outsides of the cores,
holding the core segments so that the film-shaped insulating materials of the adjacent core segments do not interfere with each other; and
sequentially performing continuous winding without cutting a cross wire between at least two exciting coils.

3. The method of manufacturing a motor stator according to claim 1, wherein the extended portion of the film-shaped insulating material is pressed into the core slot from an outer periphery after winding is performed on the core segment, the insulating material being extended by a specific dimension from the end of the outer peripheral core of the core segment to the outsides of the core, and the plurality of core segments are brought close to one another after bending, the core segments being separated and held at specific intervals, so that the extended portions of the bent film-shaped insulating materials are held between exciting coils of the plurality of core segments and a creepage insulation distance is ensured between the outer peripheral core and the exciting coil.

4. The method of manufacturing a motor stator according to claim 2, wherein the core segments are connected so as to be opened around the connecting portions from substantially parallel positions, winding is performed on the plurality of core segments which are held so as to permit no interference between the adjacent film-shaped insulating materials provided in the core slots,
the plurality of core segments are rotated about the connecting portions and the core segments are brought close to each other, the core segments are rotated until the extended portions of the film-shaped insulating materials overlap each other, the insulating materials being extended by the specific dimension from the ends of the outer peripheral cores of the adjacent core segments to the outsides of the cores,
the extended portion of the film-shaped insulating material is pressed and bent into the core slot from an outer peripheral side, the film-shaped insulating material being extended by the specific dimension from the core,
the core segments are rotated about the connecting portions again to bring the inner peripheral cores of the core segments close to one another until the extended portions of the bent film-shaped insulating materials are held between the exciting coils of the core segments, and a creepage insulation distance is ensured between the outer peripheral core and the exciting coil.

5. The method of manufacturing a motor stator according to claim 1, wherein after winding is performed on the core segments, the plurality of core segments are bent into an annular shape until overlapping is made between the extended portions of the film-shaped insulating materials extended by the specific dimension from the ends of inner peripheral cores of the adjacent core segments to the outsides of the cores,
the extended portion of the film-shaped insulating material is pressed and bent from an inner peripheral side of the annular core segment, and
the inner peripheral cores of the plurality of core segments are brought close to each other again to form an annular stator, so that the extended portions of the bent film-shaped insulating materials are held between the exciting coils of the core segments and a creepage insulation distance is ensured between the inner peripheral core and the exciting coil.

6. The method of manufacturing a motor stator according to claim 2, wherein after winding is performed on the core segments, the core segments are rotated around the connecting portions of the core segments and the core segments are brought close to one another until overlapping is made between the film-shaped insulating materials extended by the specific dimension from the ends of the inner peripheral cores of the adjacent core segments to the outsides of the cores, the plurality of core segments are bent into an annular shape,
the extended portion of the film-shaped insulating material is pressed and bent into the core slot from an inner peripheral side of the annular core segments, and
the plurality of core segments are rotated about the connecting portions of the core segments again to bring the inner peripheral cores close to one another, so that the extended portions of the bent film-shaped insulating materials are held between the exciting coils of the core segments and a creepage insulation distance is ensured between the inner peripheral core and the exciting coil.

7. The method of manufacturing a motor stator according to claim 1 or 2, wherein the film-shaped insulating material has an overlapping dimension of the extended portions on an outer peripheral side and an inner peripheral side when the extended portion of the film-shaped insulating material is bent into the core slot, the insulting material being extended by the specific dimension from the ends of the outer peripheral core and the inner peripheral core to the outsides of the cores, and interphase insulation is ensured between the adjacent exciting coils when the plurality of core segments are adjacent to one another in an annular shape to form a stator.

8. A motor stator formed into an annular shape by rounding a plurality of core segments after winding is performed on the plurality of core segments split for respective magnetic pole teeth in a circumferential direction,
wherein the stator comprises a coil hanging portion protruding toward a core slot outside a turning region of a nozzle for winding on an inner surface of an outer peripheral side wall of an insulator provided on both ends of a core of the core segment, and
a winding end line is wound and fixed on the coil hanging portion.

9. A motor stator in which a plurality of core segments are rounded and formed into an annular shape after winding is continuously performed on the plurality of core segments split for respective magnetic pole teeth in a circumferential direction without cutting a cross wire between at least two exciting coils,
wherein after the plurality of core segments are rounded to form an annular stator, a housing box made of an insulating material is provided on a coil end of a stator end, and
the cross wires provided over the exciting coils are housed in the housing box via a sheet-like insulator while being separated for respective phases, the exciting coils having been subjected to continuous winding.

10. A motor stator in which a plurality of core segments are rounded and formed into an annular shape after winding is continuously performed on the plurality of core segments split for respective magnetic pole teeth in a circumferential direction,
wherein as to a height of an inner peripheral side wall of an insulator provided on both ends of a core of the core segment, a core slot internal dimension up to a boundary between adjacent core slots is used as a maximum dimension, and
two corners outside the inner peripheral side wall are cut smaller than an outer periphery of a wound exciting coil while strength of the inner peripheral side wall is maintained.
